(19) United States
(12) Patent Application Publication
(10) Pub. No.: US 2003/0035916 A1
(43) Pub. Date: Feb. 20, 2003

(54) Casing for receiving notes

(76) Inventor: Yih-Fa Wang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/930,461

(22) Filed: Aug. 16, 2001

(51) Int. Cl. B32B 7/06

(52) U.S. Cl. 428/42.3

(57) ABSTRACT

A notes casing includes a base and a pile of notes is connected to the base by adhering a first adhesive portion on the pile of notes on the base. A mirror has a second adhesive portion which is adhered on the first adhesive portion. A cover has an end adhered on the second adhesive portion.

### FIELD OF THE INVENTION

The present invention relates to a casing for receiving notes and the casing has decoration function and includes a mirror therein.

### BACKGROUND OF THE INVENTION

A conventional way to collect the notes is to accumulate the notes to be a note cube so that the users peel the top note each time. However, the note cube has no proper casing to receive so that they are easily to be dirty. A conventional casing for receiving the notes is a plastic or paper casing having an open top so that the notes cube is put in the casing. The casing generally is a cube casing and has no decoration function so that it is not satisfied by the market requirements. Besides, the conventional casing for receiving the notes has an open top so that the top note does not covered or protected and could be contaminated.

### SUMMARY OF THE INVENTION

In accordance with one aspect of the present invention, there is provided a notes casing which comprises a base and a pile of notes has a first adhesive portion which is adhered on the base. A mirror has a second adhesive portion which is adhered on the first adhesive portion. A cover has an end adhered on the second adhesive portion.

The primary object of the present invention is to provide a notes casing that has a decoration cover, and a mirror and a pile of notes are connected between the base and the cover of the casing.

The present invention will become more obvious from the following description when taken in connection with the accompanying drawings which show, for purposes of illustration only, two preferred embodiments in accordance with the present invention.

### BRIEF DESCRIPTION OF THE DRAWINGS

FIG. 1 is an exploded view to show the notes casing of the present invention;

FIG. 2 is a perspective view to show the notes casing of the present invention;

FIG. 3 is a perspective view to show the notes casing of the present invention, wherein the cover is opened;

FIG. 4 is an exploded view to show another embodiment of the notes casing of the present invention;

FIG. 5 is a perspective view to show the notes casing as shown in FIG. 4, and

FIG. 6 is a perspective view to show the notes casing as shown in FIG. 4, wherein the cover is opened.

### DETAILED DESCRIPTION OF THE PREFERRED EMBODIMENTS

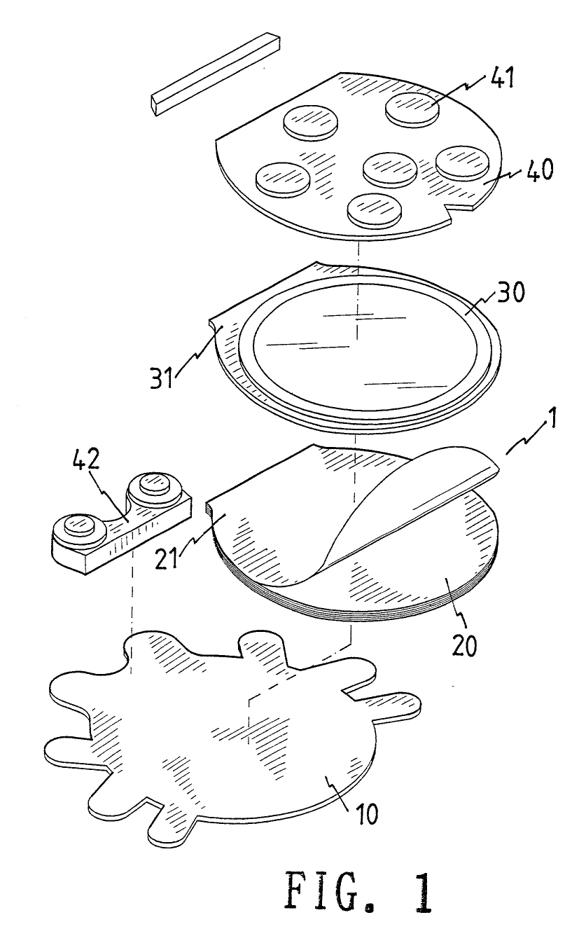

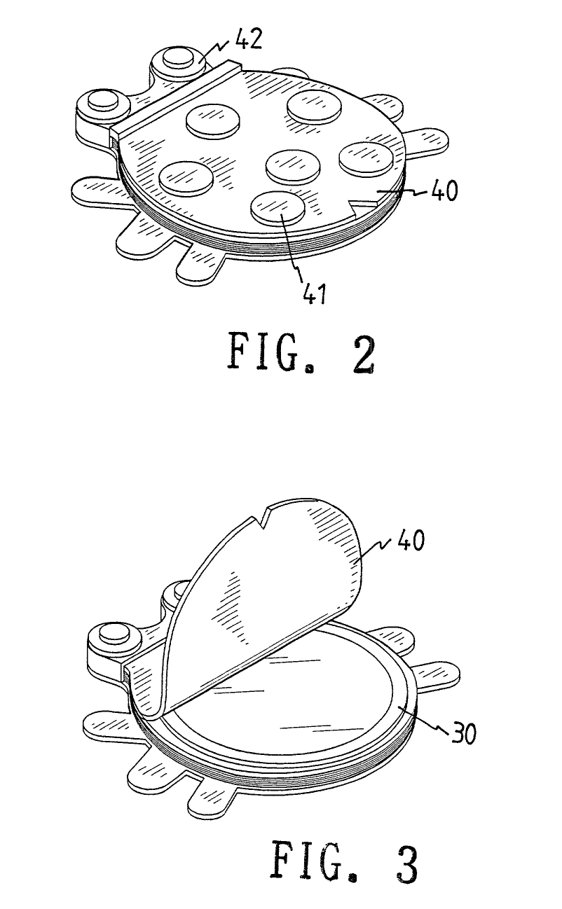

Referring to FIGS. 1 to 3, the notes casing 1 of the present invention comprises a base 10 which has decoration portions on a periphery thereof. A pile of notes 20 has a first adhesive portion 21 which is adhered on the base 10. A mirror 30 has a second adhesive portion 31 which is adhered on the first adhesive portion 21. A cover 40 has an end adhered on the second adhesive portion 31 and a plurality of decoration members 41 are adhered on the cover 40. A decoration head portion 42 is connected to the base 10 so as to decorate the notes casing to be a frog-shaped casing.

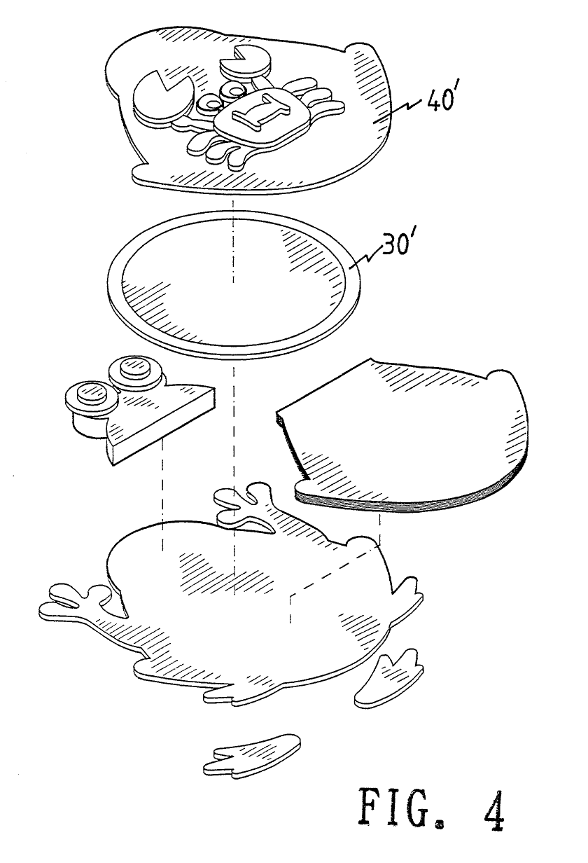

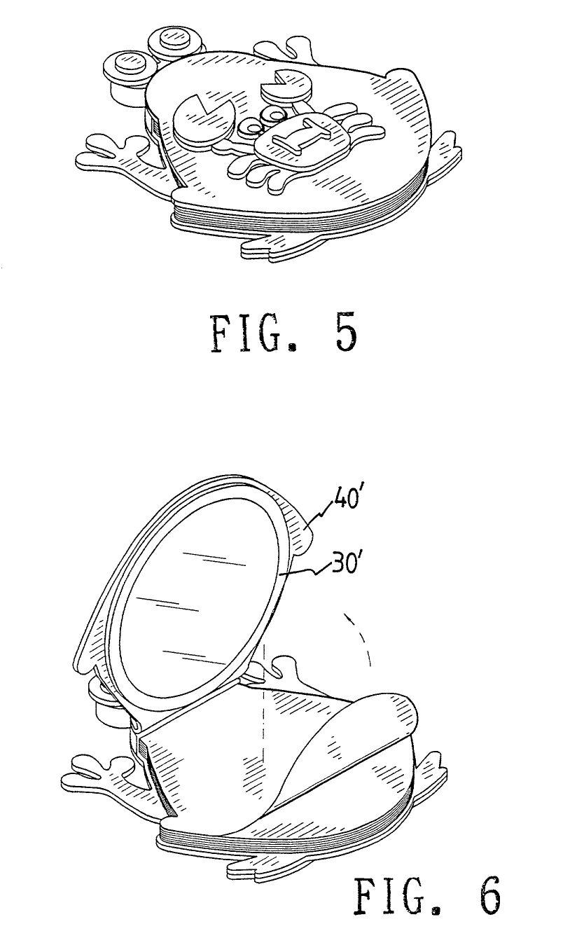

FIGS. 4 to 6 show another embodiment of the notes casing wherein the mirror 30′ is adhered on an underside of the cover 40′ so that when the cover 40′ is opened, the mirror 30′ is pivoted to a position ready for use. The number of the part such as the mirror can be multiple and the type of the parts can be various.

While we have shown and described the embodiment in accordance with the present invention, it should be clear to those skilled in the art that further embodiments may be made without departing from the scope of the present invention.

What is claimed is:

1. A notes casing comprising:
a base;
a pile of notes having a first adhesive portion which is adhered on said base;
a mirror having a second adhesive portion which is adhered on said first adhesive portion, and
a cover having an end adhered on said second adhesive portion.

2. The notes casing as claimed in claim 1 further comprising a decoration head portion connected to said base.

3. The notes casing as claimed in claim 1, wherein said cover has decoration members adhered on said cover.

4. The notes casing as claimed in claim 1, wherein said cover is adhered on an underside of the cover.
